(19) United States
(12) Patent Application Publication
(10) Pub. No.: US 2005/0220025 A1
(43) Pub. Date: Oct. 6, 2005

(54) Flow control device

(76) Inventor: Tsutomu Noguchi, Kawasaki (JP)

Correspondence Address: KATTEN MUCHIN ROSENMAN LLP, 575 MADISON AVENUE, NEW YORK, NY, 10022-2585, US

(21) Appl. No.: 11/139,419

(22) Filed: May 26, 2005

Related U.S. Application Data
(63) Continuation of application No. PCT/JP03/06815, filed on May 30, 2003.

(51) Int. Cl. H04L 12/26

(52) U.S. Cl. 370/235; 370/282

(57) ABSTRACT

In a flow control device performing a credit-based control, in order to eliminate a deadlock state with an opposed device due to a discard of data or a credit, a flow management table of a transmitting side flow control device stores a number of data transmitted to an opposed device and a number of credits received from the opposed device, and a management portion transmits a request for correction information to the opposed device and corrects the data transmission number and the credit reception number based on the correction information received. Alternatively, a management portion of a receiving side flow control device notifies the correction information (e.g. difference between data transmission number and data reception number, and credit transmission number) for the data transmission number and the credit reception number of the opposed device in response to the correction information request from the opposed device.

### BACKGROUND OF THE INVENTION

1. Field of the Invention

The present invention relates to a flow control device, and in particular to a flow control device performing a credit-based control.

Together with a recent development of communication technologies, communication rates have been increasingly enhanced, in which high-speed communication a flow control for communications without discarding data has become increasingly important.

2. Description of the Related Art

As a flow control system used for a data transfer between two devices, there are (1) XON/XOFF system, (2) Credit-based flow control system and the like.
(1) XON/XOFF system: A flow control device on a receiving side notifies XON (transmission start) or XOFF (transmission stop) to a flow control device on a transmitting side. A flow control device on the transmitting side starts/stops transmitting data based on the notification. In the XON/XOFF system, there is a possibility that an overflow due to a time lag between a transmission and a reception occurs.

(2) Credit-based flow control system: FIG. 10 shows a general credit-based flow control system 100z, which is composed of a transmitting side flow control device 10z, a receiving side flow control device 20z, and transmission lines 200_1 and 200_2 connecting the flow control devices 10z and 20z.

The transmitting side flow control device 10z is composed of queues 11_1-11_{—}n (hereinafter, occasionally represented by a reference numeral 11), and a flow management table 12z. The flow management table 12z is composed of a data transmission number 12a, a credit reception number 12b, and a threshold 12c corresponding to each queue 11.

The receiving side flow control device 20z is provided with queues 21_1-21_{—}n (hereinafter, occasionally represented by a reference numeral 21). These queues 21_1-21_{—}n respectively correspond to the queues 11_1-11_{—}n on the transmitting side.

Data 71 temporarily stored in e.g. the queue 11_1 on the transmitting side are transmitted to the receiving side flow control device 20z through the transmission line 200_1, so that the data transmission number 12a of the flow management table 12z on the transmitting side is incremented by “1”.

In the receiving side flow control device 20z, the data 71 are temporarily stored in the queue 21_1 and then transferred to a subsequent device. Every time the data are transferred, the receiving side flow control device 20z transmits a credit 82 including an identifier 82h2 of the queue 21_1 which has transferred the data and a credit update bit 82h1=“1” indicating the credit to the transmitting side flow control device 10z.

In the transmitting side flow control device 10z, the credit reception number 12b corresponding to the queue 11_1 of the flow management table 12z is incremented by “1”. The “difference” between the data transmission number 12a and the credit reception number 12b corresponds to a data number held in the queue 21_1 on the receiving side, if a time lag between a transmission and a reception is neglected.

In case of the above-mentioned “difference”<threshold 12c, the transmitting side flow control device 10z transmits the data 71 held in the queue 11_1. In case of the above-mentioned “difference”≧threshold 12c, the transmitting side flow control device 10z does not transmit the data 71. Thus, an overflow of the queue 21_1 is eliminated.

Such a credit-based flow control system has the following problems, which will be described referring to operation examples (1)-(3) shown in FIGS. 11-13:

FIG. 11 shows an operation example (1) of the credit-based flow control system. This operation example (1) specifically shows only a case where the data 71 are transmitted from the queue 11_1 on the transmitting side to the queue 21_1 on the receiving side, and the flow management table 12z only shows numerical values corresponding to the queue 11_1 and does not show the numerical values corresponding to the queues 11_2-11_{—}n.

Also, in FIG. 11, the queues 11 and 21 are not shown for simplifying the figure. The operation example (1) will now be described.
Timing T61: The transmitting side flow control device 10z transmits data 71_1-71_3 from the queue 11_1. The data 71_2 thereamong are discarded (T61a) on the outward transmission line 200_1 (see FIG. 10), and the remaining data 71_1 and 71_3 reach the receiving side flow control device 20z.
Timing T62: The receiving side flow control device 20z, after preliminarily storing the data 71_1 and 71_3 in the queue 21_1, transfers the data (D301 and D302) to e.g. another subsequent device. The receiving side flow control device 20z transmits credits 82_1 and 82_2 respectively corresponding to the transferred data 71_1 and 71_3 to the transmitting side flow control device 10z.
Timing T63: As a result, the data stored in the queue 21_1 are eliminated.
Timing T64: The transmitting side flow control device 10z receives the credits 82_1 and 82_2.
Timing T65: As a result, it is rendered in the flow management table 12z that the data transmission number 12a=“3”, the credit reception number 12b=“2” and the threshold 12c=“5 (preset value)”.

Namely, the flow management table 12z indicates that “1” piece of data (3 (data transmission number 12a)−2 (credit reception number 12b)) is stored and remains in the queue 21_1 on the receiving side.

Thus, when the data 71_2 are discarded in the outward transmission line 200_1, the credit corresponding to the data 71_2 is not returned. Therefore, it is not possible to estimate an accurate data number stored in the queue 21_1 based on the flow management table 12z.

FIG. 12 shows an operation example (2) of the credit-based flow control system. The operation example (2) shows, in the same way as the operation example (1), only a case where the data 71 are transmitted from the queue 11_1 to the queue 21_1, and the flow management table 12z only shows the numerical values corresponding to the queue 11_1, not showing the queues 11 and 21 themselves. The operation example (2) will now be described.
Timing T71: The transmitting side flow control device 10z transmits the data 71_1-71_3 from the queue 11_1. The data 71_1-71_3 reach the receiving side flow control device 20z.
Timings T72 and T73: The receiving side flow control device 20z, after having temporarily stored the data 71_1-71_3 in the queue 21_1, transfers the data (D401-D403) to the subsequent device. As a result, the data stored in the queue 21_1 are eliminated.

Also, the receiving side flow control device 20z transmits the credits 82_1-82_3 respectively corresponding to the transferred data 71_1-71_3 to the transmitting side flow control device 10z. The credit 82_2 among the credits 82_1-82_3 is discarded (T72a) in the homeward transmission line 200_2.
Timing T74: The transmitting side flow control device 10z receives the credits 82_1 and 82_3.
Timing T75: As a result, it is rendered in the flow management table 12z that the data transmission number 12a=“3”, the credit reception number 12b=“2” and the threshold 12c=“5 (preset value)”. Namely, the flow management table 12z indicates that “1” piece of data (3 (data transmission number 12a)−2 (credit reception number 12b)) is stored and remains in the queue 21_1 on the receiving side.

Thus, when the credit 82_2 is discarded in the homeward transmission line 200_2, it is also not possible to estimate an accurate data number stored in the queue 21_1 based on the flow management table 12z.

FIG. 13 shows an operation example (3) of the credit-based flow control system. This operation example (3) shows, in the same way as the operation example (1), only a case where the data 71 are transmitted from the queue 11_1 to the queue 21_1, and the flow management table 12z only shows the numerical values corresponding to the queue 11_1, not showing the queues 11 and 21. The operation example (3) will now be described.
Timing T81: The transmitting side flow control device 10z sequentially transmits the data 71_1-71_5 from the queue 11_1. The data 71_2 and 71_4 among the data 71_1-71_5 are discarded (T81a and T81b) on the outward transmission line 200_1, and only the data 71_1, 71_3 and 71_5 reach the receiving side flow control device 20z.
Timing T82: The receiving side flow control device 20z, after having temporarily stored the data 71_1 in the queue 21_1, transfers the data (D501) to the subsequent device. The receiving side flow control device 20z transmits the credit 82_1 corresponding to the data 71_1 to the transmitting side flow control device 10z.
Timing T83: The transmitting side flow control device 10z receives the credit 82_1. At this time, it is rendered in the flow management table 12z that the data transmission number=“5”, the credit reception number=“1” and the threshold=“5 (preset value)”.
Timing T84: The transmitting side flow control device 10z calculates “5 (data transmission number)”−“1 (credit reception number)”=“4”, recognizes the data number=“4” as temporarily stored in the queue 21_1 of the receiving side flow control device 20z, determines that it is possible to transmit “1” piece of data (5 (threshold)−4 (data number)) and transmits data 71_6.

As a result, it is rendered in the flow management table 12z that the data transmission number=“6”, the credit reception number=“1”, and “5 (threshold)”=(6 (data transmission number)−1 (credit reception number)), which leads to a transmission disabled state (not deadlock state) of data.
Timing T85: The queue 21_1 on the receiving side transfers the data (D502) to the subsequent stage after having temporarily stored the data 71_3. The credit 82_2 corresponding to the transfer D502 is returned to the transmitting side.
Timing T86: Since it is rendered in the flow management table 12z after the reception of the credit 82_2 that the data transmission number=“6”, the credit reception number=“2”, and “4” (6 (data transmission number)−2 (credit reception number))<“5 (threshold)”, the transmitting side flow control device 10z determines that the transmission of a single piece of data is possible (the transmission disabled state is resolved). Accordingly, the queue 11_1 transmits data 71_7.

As a result, it is rendered in the flow management table 12z that the data transmission number=“7”, the credit reception number=“2”, and “5 (threshold)”=(7 (data transmission number)−2 (credit reception number)), which leads to the transmission disabled state of data.
Timing T87: The queue 21_1 on the receiving side sequentially and temporarily stores the received data 71_5-71_7 to be transferred (D503-D505) to the subsequent stage. The credits 82_3-82_5 corresponding to the data transfer are sequentially returned to the transmitting side.
Timing T88: At this time, the queue 21_1 on the receiving side enters a state where no data are stored.
Timing T89: When the credits 82_3-82_5 are discarded (T87a-T87c) on the transmission line 200_2, the flow management table 12z indicates, in the same way as the timing T86, the state where the transmission of the data is disabled.

Since the total of the discarded data number “2” and the discarded credit number “3” equals the threshold “5”, this transmission disabled state is never resolved. Namely, if the total of the data discard occurring on the outward line and the credit discard occurring on the homeward line becomes equal to or more than the threshold despite of the fact that no residual data of the queue 21_1 on the receiving side remain, the credit-based flow control between the transmission and the reception falls into a deadlock state T90, which leads to the transmission disabled state of data.

Namely, the deadlock state is a state where the transmission disabled state and a transfer completion of all of the data in the queue 21 in the opposed device occur at the same time.

Also, there is a digital traffic switch with credit-based flow control (buffer control). This switch is a type having multiple input ports, multiple output ports and a switch fabric for switching protocol data units received at any of the input ports to any of the output ports, and includes an input buffer associated with each input port and having one or more transmission queues; an output buffer having one or more reception queues; means for receiving protocol data units for specific output ports respectively at the input ports, means for assigning the protocol data units to the reception queues arranged so that the protocol data units for specific output ports respectively may be stored; means for assigning the protocol data units to the transmission queues arranged so that the protocol data units for specific output ports respectively may be stored; means for polling, in a predetermined order, the reception queues arranged so that the protocol data units for the specific output ports respectively may be stored; means for assigning a credit to each transmission queue associated with the same output port as a polled reception queue having a sufficiently light load; means for polling the transmission queues in a predetermined order; means for transmitting the protocol data unit from a polled transmission queue having sufficient amounts of credits to the reception queue associated with the same output port as the polled transmission queue and for reducing the amount of credits assigned to the polled transmission queue in relation to the length of the transmitted protocol data unit; and means for further transmitting the protocol data unit transmitted from the reception queue to a destination output port (see e.g. Patent Document 1).

The above-mentioned flow control is for determining a transmission priority order by a service quality and for preventing a priority order blocking, and suppresses the blocking by controlling a credit returned per service quality. The above-mentioned flow control does not resolve a deadlock state due to a discard of data or a credit.

<Patent Document 1>

Japanese Translation of PCT International Application No. 2002-518937

Thus, in the prior art flow control device, if data or a credit is discarded in the middle of the transmission, the flow management table of the transmitting side flow control device does not reflect the data number stored in the queue on the receiving side, which leads to a deadlock state at the worst.

### SUMMARY OF THE INVENTION

It is accordingly an object of the present invention to provide a flow control device performing a credit-based control, which eliminates a deadlock state with an opposed device due to a discard of data or a credit.

In order to achieve the above-mentioned object, a flow control device on a transmitting side according to the present invention comprises: a flow management table storing a number of data transmitted to an opposed device and a number of credits received from the opposed device; and a management portion transmitting a request for correction information to the opposed device and correcting the data transmission number and the credit reception number in the flow management table based on the correction information responded by the opposed device.

Namely, a flow management table stores a data transmission number obtained by counting data transmitted to an opposed device and a credit reception number obtained by counting credits received from the opposed device.

A management portion requests, from the opposed device, information (namely, information concerning a discard number of data on an outward line from the transmitting side flow control device to the opposed device, and information concerning a discard number of credits on a homeward line) for correcting e.g. the data transmission number and the credit reception number.

The management portion corrects the data transmission number and the credit reception number within the flow management table based on the correction information responded by the opposed device.

Thus, even if the discard of data or credits occurs between the transmitting side flow control device and the opposed device, the transmitting side flow control device can grasp a data reception state and a transfer state at the opposed device. Accordingly, it becomes possible to eliminate the deadlock state between the both devices.

Also, in the above-mentioned present invention, the correction information request may include the data transmission number, and the correction information may comprise a difference between the data transmission number and a data reception number of the opposed device, and a credit transmission number of the opposed device.

Namely, the management portion transmits the correction information request including the data transmission number, and receives a difference between the data transmission number and the data reception number of the opposed device, and the credit transmission number from the opposed the device as the correction information.

Thus, it becomes possible to correct the data transmission number of the flow management device with a difference=“data discard number on the outward line”, and to correct the credit reception number with the credit transmission number.

Also, in the above-mentioned present invention, the management portion may store the data transmission number at a time of transmitting the correction information request, and the correction information may comprise a data reception number and a credit transmission number of the opposed device.

Thus, it becomes possible to correct the data transmission number based on the difference=“data discard number on the outward line” between the data transmission number stored and the data reception number, and to correct the credit reception number based on the credit transmission number.

Also, in the above-mentioned present invention, the management portion may transmit the correction information request in a predetermined format at predetermined intervals.

Thus, it becomes possible to correct the data transmission number and the credit reception number at time intervals corresponding to e.g. the data discard number on the outward line or the credit discard number on the homeward line, i.e. the time intervals at which a deadlock state does not occur on the opposed device side.

Also, in the above-mentioned present invention, unless the correction information is received within a predetermined time after having transmitted the correction information request, the management portion may retransmit the correction information request.

Thus, a case can be addressed where the correction information request is discarded without being delivered to the opposed device, or a case where although the correction information request is delivered to the opposed device, the correction information is not delivered to the transmitting side device but discarded.

Furthermore, the above-mentioned present invention may further comprise one or more queues temporarily storing the data; the flow management table may manage the data transmission number and the credit reception number corresponding to each queue, and the management portion may transmit the correction information request for each queue.

Namely, the transmitting side flow control device is further provided with one or more queues. The flow management table manages the data transmission number and the credit reception number corresponding to each queue. The management portion transmits the correction information request for each queue, and receives the correction information corresponding to each queue.

Thus, it becomes possible to manage data transmitted for a single queue or a plurality of queues, and to correct the data transmission number and the credit reception number corresponding to each queue.

Also, in order to achieve the above-mentioned object, a flow control device on a receiving side according to the present invention comprises: a queue temporarily storing data received from an opposed device; a flow management table storing a number of the data received from and a number of credits transmitted to the opposed device; and a management portion responding correction information for a correction information request from the opposed device.

Namely, a queue temporarily stores data received from an opposed device. A flow management table stores a number of the data received by the queue (data reception number), and a number of credits transmitted to the opposed device (credit transmission number). A management portion responds correction information for e.g. a data transmission number and a credit reception number of the opposed device, for a correction information request from the opposed device.

Thus, it becomes possible for the opposed device to estimate the discarded data number and the discarded credit number based on the correction information, namely, to correct the data transmission number and the credit reception number, so that the deadlock state between both devices can be eliminated.

Also, in the above-mentioned present invention, the correction information request may include a data transmission number, and the correction information may comprise a difference between a data transmission number of the opposed device and the data reception number, and a credit transmission number.

Also, in the above-mentioned present invention, the correction information may comprise the data reception number and the credit transmission number.

Furthermore, the queue may comprise a plurality of queues and the flow management table may manage the data reception number and the credit transmission number for each of the queues, and the management portion may transmit the correction information for correction information request for each of the queues.

Namely, it becomes possible to correct the data transmission number and the credit reception number corresponding to each of the queues. Thus, it becomes possible to manage the data received by a plurality of queues per queue, and to correct the data transmission number and the credit reception number in the opposed device corresponding to each of the queues.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing an embodiment of a flow control system composed of a transmitting side and receiving side flow control devices according to the present invention;

FIG. 2 is a diagram showing a transmission and reception examples of data cells and an outward and homeward management cells exchanged between a transmitting side and receiving side flow control devices according to the present invention;

FIGS. 3A and 3B are diagrams showing arrangements of an outward and homeward management cells exchanged between a transmitting side and receiving side flow control devices according to the present invention;

FIG. 4 is a flowchart showing an operation procedure example in a transmitting side flow control device according to the present invention;

FIG. 5 is a flowchart showing an operation procedure example in a receiving side flow control device according to the present invention;

FIG. 6 is a time chart showing an operation procedure example (1) of a transmitting side and receiving side flow control devices according to the present invention;

FIG. 7 is a diagram indicating values set in an outward and homeward management cells in an operation example (1) of a transmitting side and receiving side flow control devices according to the present invention;

FIG. 8 is a time chart showing an operation procedure example (2) of a transmitting side and receiving side flow control devices according to the present invention;

FIGS. 9A and 9B are time charts showing an operation procedure example (3) of a transmitting side and receiving side flow control devices according to the present invention;

FIG. 10 is a block diagram showing an arrangement of a general credit-based flow control system;

FIG. 11 is a time chart showing an operation procedure example (1) of a general credit-based flow control system;

FIG. 12 is a time chart showing an operation procedure example (2) of a general credit-based flow control system; and

FIG. 13 is a time chart showing an operation procedure example (3) of a general credit-based flow control system.

### DESCRIPTION OF THE EMBODIMENTS

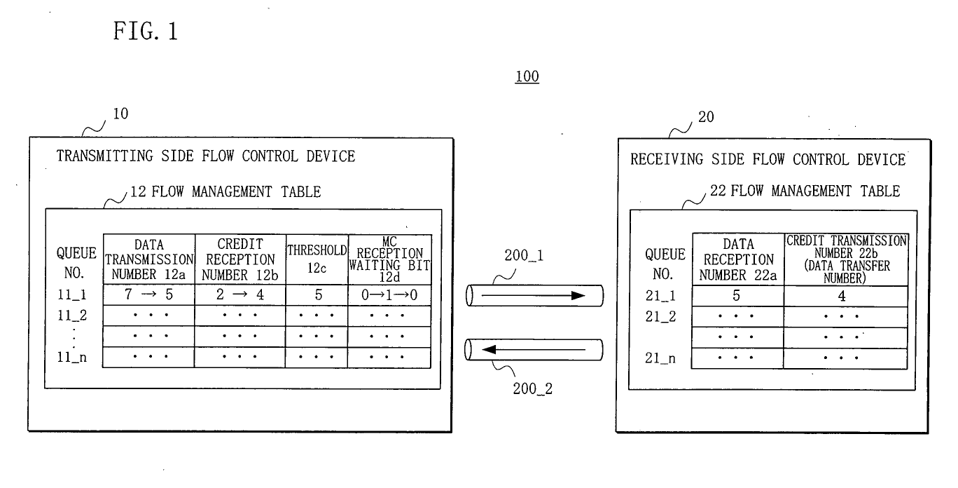

FIG. 1 shows an embodiment of a transmitting side flow control device 10 and a receiving side flow control device 20 according to the present invention. In FIG. 1, a flow control system 100 is arranged by connecting the transmitting side flow control device 10 and the receiving side flow control device 20 with transmission lines 200_1 and 200_2.

The transmitting side flow control device 10 is provided with queues 11_1-11_{—}n (not shown; hereinafter, occasionally represented by a reference numeral 11) and a transmitting side flow management table 12. This table 12 is composed of a data transmission number 12a, a credit reception number 12b, a threshold 12c and an MC reception waiting bit 12d corresponding to each queue 11.

The receiving side flow control device 20 is provided with queues 21_1-21_{—}n (not shown; hereinafter, occasionally represented by a reference numeral 21) and a receiving side flow management table 22. This table 22 is composed of a data reception number 22a and a credit transmission number 22b corresponding to each queue 21.

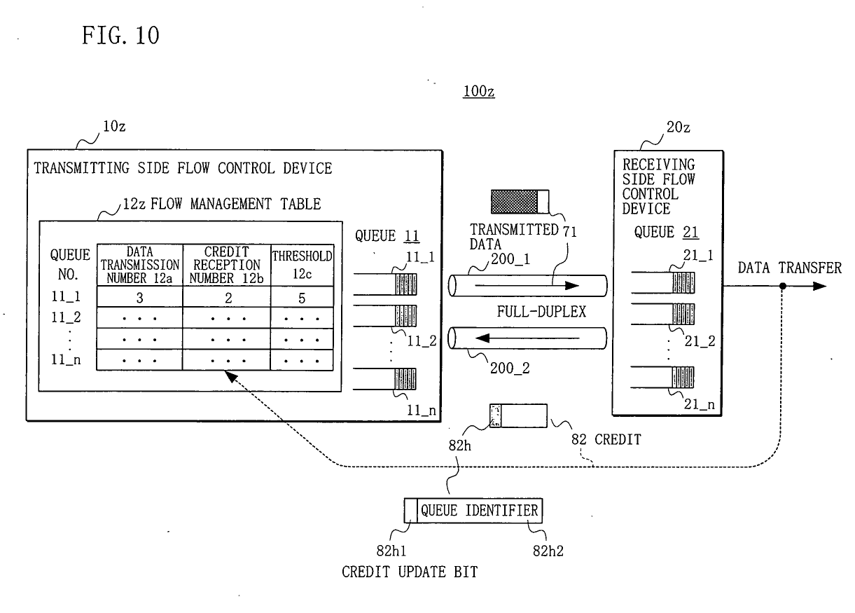

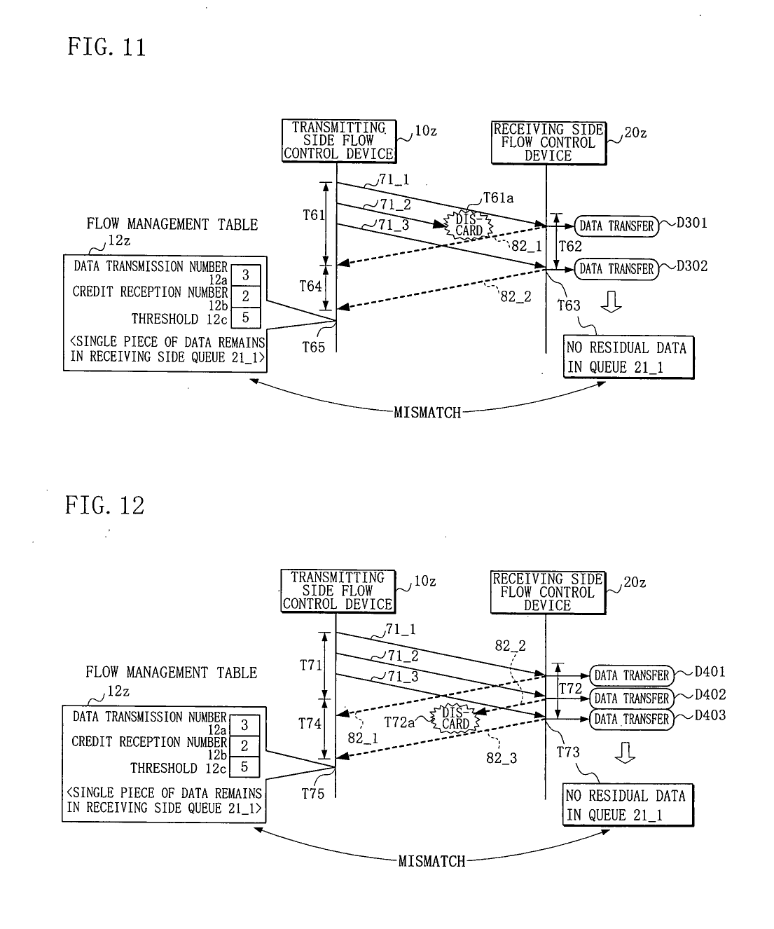

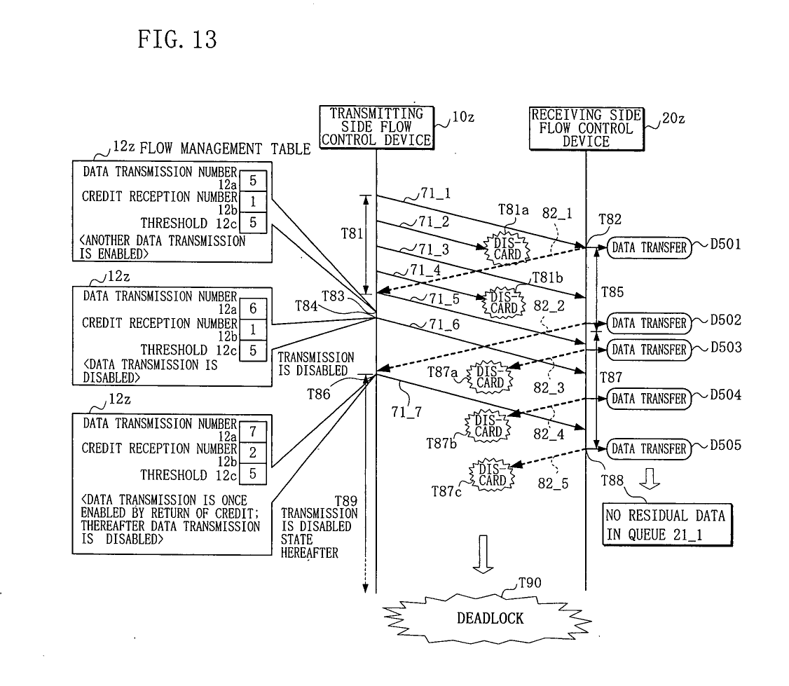

In the same way as the queues 11 and 21 shown in FIG. 10, the queues 11_1-11_{—}n on the transmitting side respectively correspond to the queues 21_1-21_{—}n on the receiving side such that the data held in the queue 11_1 are transmitted to the queue 21_1 corresponding to the queue 11_1.

FIG. 2 shows user data and management data transmitted through the transmission lines 200_1 and 200_2 connecting the transmitting side flow control device 10 and the receiving side flow control device 20.

The user data are mounted on data cells 71_1-71_9 (hereinafter, occasionally represented by a reference numeral 71; or occasionally simply referred to as data 71), and transmitted to the flow control device 20 from the flow control device 10 through the transmission line 200_1. A management cell (hereinafter, occasionally abbreviated as MC) 70 on which the management data are mounted is transmitted in the midst of the data 71.

Similarly, data cells 81_1-81_9 (hereinafter, occasionally represented by a reference numeral 81) are transmitted from the flow control device 20 to the flow control device 10, and a management cell 80 is transmitted in the midst of the data cell 81.

In this embodiment, by noticing the data 71, it is supposed that the flow control device 10 is a transmitting side, and the flow control device 20 is a receiving side. The MC 70 is referred to as an outward MC 70 (correction information request), and the MC 80 is referred to as a homeward MC 80 (correction information).

It is to be noted that while the user data and the management data are mounted on the cell to be transmitted in this embodiment, a packet, a frame or the like may be substituted for the cell to be transmitted.

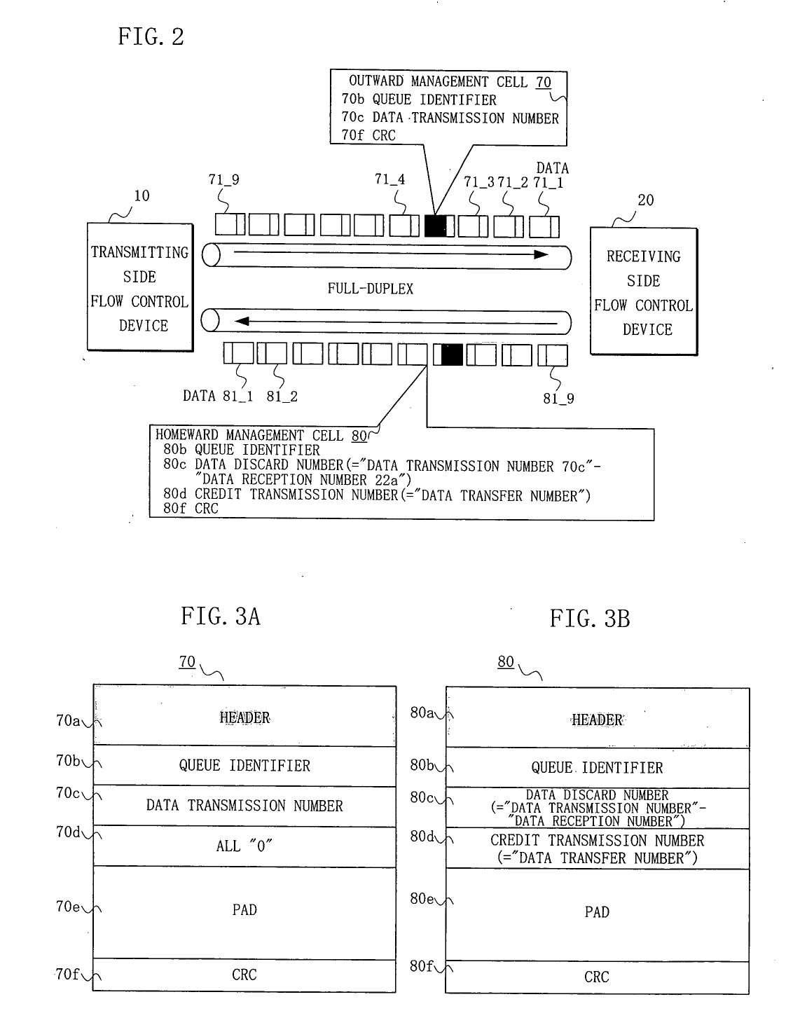

FIGS. 3A and 3B show arrangements of the management cell (MC). FIG. 3A shows the outward MC 70, which is composed of a header 70a, a queue identifier 70b, a data transmission number 70c, a reserve 70d, a padding 70e and a CRC 70f. FIG. 3B shows the homeward MC 80, which is composed of a header 80a, a queue identifier 80b, a data discard number 80c, a credit transmission number 80d, a padding 80e and a CRC 80f.

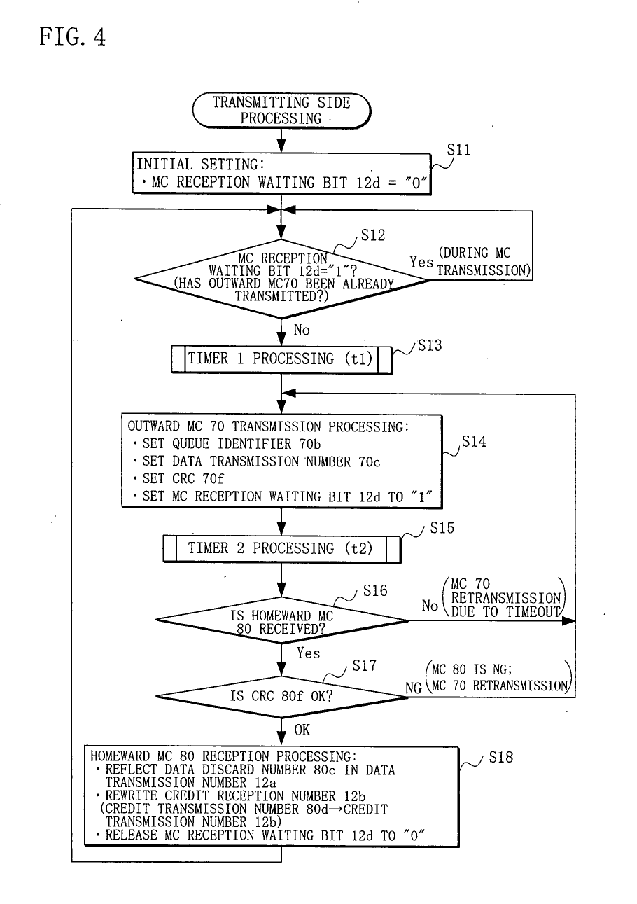

FIG. 4 shows an operation example of the transmitting side flow control device 10. This operation example will now be described by specifically noticing only the MCs 70 and 80 concerning the queue 21_1 on the receiving side, based on the settings of the queue No.=“11_1” in the flow management table 12 shown in FIG. 1. It is to be noted that as for the queue identifier 70b of the outward MC 70 and the queue identifier 80b of the homeward MC 80, the settings are the same respectively, so that the description thereof will be omitted.
Step S11 [initial setting]: The MC reception waiting (queuing) bit 12d of the flow management table 12 (see FIG. 1) is set to “0”. The MC reception waiting bit 12d=“0” in this description means that the outward MC 70 is not transmitted. The MC reception waiting bit 12d=“1” means that the outward MC 70 has been already transmitted, and the transmitting side flow control device 10 is in a waiting state of the homeward MC 80 from the opposed device (receiving side flow control device) 20.
Step S12: Since the MC reception waiting bit 12d=“0 (outward MC 70 has not been transmitted)”, the process proceeds to step S13.
Step S13 [timer 1 processing]: The transmitting side flow control device 10 waits for a predetermined time t1. The time t1 is a transmission time interval of the outward MC 70.
Step S14 [outward MC 70 transmission processing]: The outward MC 70 (see FIGS. 2 and 3A) is transmitted. Namely, the queue identifier 70b=“11_1”, the data transmission number 70c=“7”, the reserve 70d=all “0”, the padding 70e and the CRC 70f of the outward MC 70 are set, whereby the outward MC 70 is transmitted to the receiving side flow control device 20. Furthermore, the MC reception waiting bit 12d is set to “1”.
Step S15 [timer 2 processing]: The transmitting side flow control device 10 waits for a predetermined time t2. The time t2 is a time at which the homeward MC 80 (see FIGS. 2 and 3B) that is a response to the outward MC 70 has to be returned after the transmission of the outward MC 70.
Step S16: When the homeward MC 80 is not received, either the outward MC 70 or the homeward MC 80 is supposed to have been discarded midway. Therefore, the process returns to step S14 and retransmits the outward MC 70.

When the homeward MC 80 is received, the process proceeds to subsequent step S17.
Step S17: When the CRC 80f of the homeward MC 80 is checked and an error is found, the homeward MC 80 is discarded and the process returns to step S14 to retransmit the outward MC 70.

Namely, until the homeward MC 80 for the outward MC 70 transmitted returns without an error, the transmission of the outward MC 70 is repeated.
Step S18 [homeward MC 80 reception processing]: Correction or setting of the flow management table 12 is performed. Namely, (1) the data discard number 80c=“e.g. 2” of the homeward MC 80 is reflected to the data transmission number 12a, so that the data transmission number 12a is changed from “7” to “5”. (2) The credit reception number 12b is rewritten into the credit transmission number 80d=“4” of the homeward MC 80. (3) The MC reception waiting bit 12d is released to “0”. The process returns to step S12.

Thus, the error of the flow management table 12 due to the data number discarded on the outward line and the credit discarded on the homeward line can be corrected.

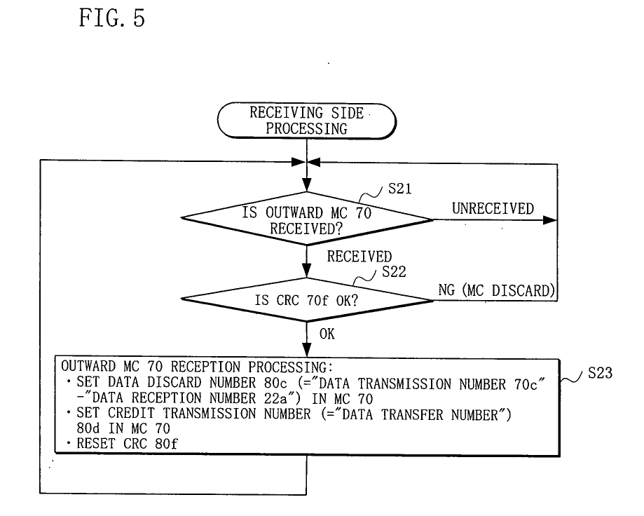

FIG. 5 shows an operation example of the receiving side flow control device 20. This operation example will now be described by specifically noticing only the MCs 70 and 80 concerning the queue 21_1 on the receiving side. Namely, the operation example will be described based on values of the data reception number 22a and the credit transmission number 22b corresponding to the queue No. “21_1” of the flow management table 22 shown in FIG. 1.

The flow management table 22 indicates that “as for the data number stored in the queue 21_1”, the data reception number 22a=“5”, and the “data number transferred from the queue 21_1” (=“the credit number transmitted to the transmitting side”) is credit transmission number 22b=“4”.
Steps S21 and S22: Whether or not the outward MC 70 (see FIG. 3A) is received is determined. When the outward MC 70 is received, the presence/absence of the transmission error of the outward MC 70 is checked with the CRC 70f. In the presence of error, the outward MC 70 is discarded and the process returns to step S21. In the absence of error, the process proceeds to step S23.
Step S23 [outward MC 70 reception processing]: A management portion (not shown) calculates the CRC 80f with the difference=“2” between the data transmission number 70c of the outward MC 70=“7” and the data reception number 22a=“5” being made the data discard number 80c, and with the credit transmission number 22b=“4” of the flow management table 22 being made the credit transmission number 80d=“4”, and prepares the homeward MC 80 to be returned to the transmitting side flow control device 10.

Thus, it becomes possible for the transmitting side flow control device 10 to recognize the data discard number of the outward line=“2” and an actual credit transmission number 22b=“4”.

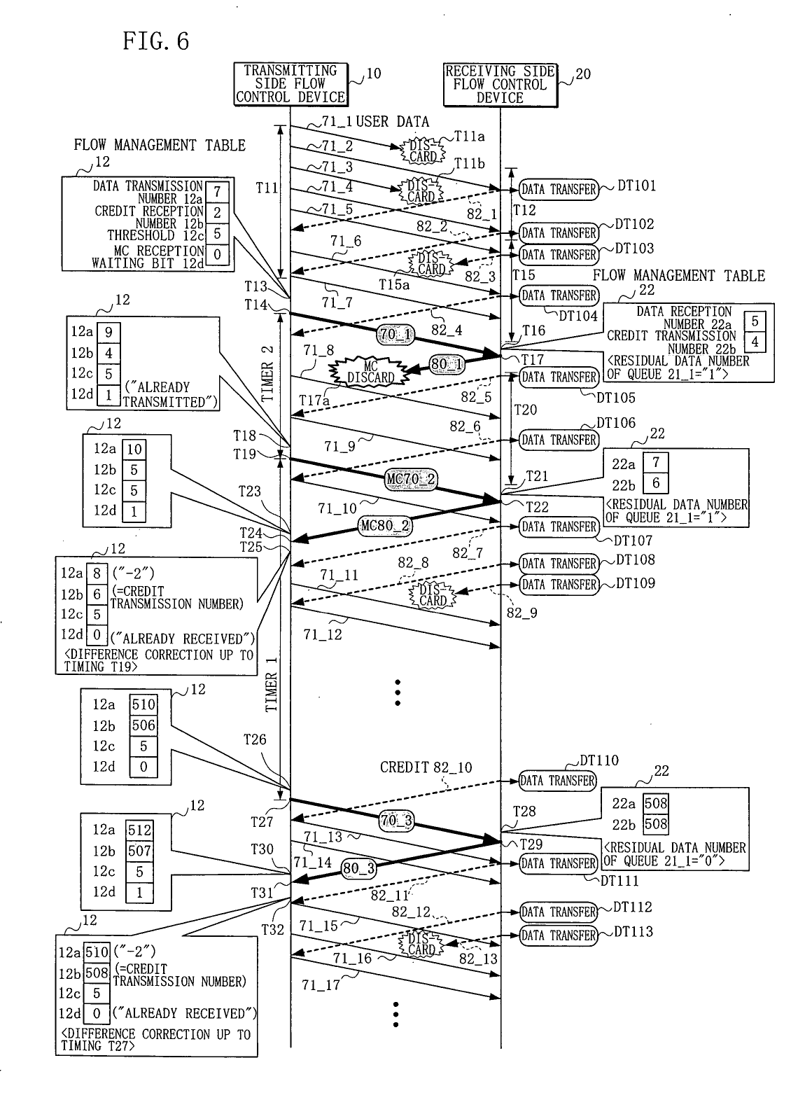

FIG. 6 shows an operation procedure of the transmitting side flow control device 10 and the receiving side flow control device 20. This operation procedure will now be described. In this description, only the data 71 and MCs 70 and 80 concerning the queues 11_1 and 21_1 in the same manner as the case of FIGS. 4 and 5 will be described.

It is to be noted that the data transmission number 12a corresponding to the queue 11_1 of the flow management table 12 in the initial state is set to “0”, the credit reception number 12b is set to “0”, and the threshold 12c is set to “5” and MC reception waiting bit is set to “0” (not shown).
Timing T11: The transmitting side flow control device 10 transmits the data 71_1-71_7 to the receiving side flow control device 20. It is supposed that the data 71_1 and 71_3 among the data 71_1-71_7 are discarded (T11a and T11b) during the transmission.
Timing T12: The queue 21_1 in the flow control device 20 stores the data 71_2 and 71_4, transfers (DT11 and DT102) the data to the subsequent stage and returns the credits 82_1 and 82_2 corresponding to the transfer to the transmitting side flow control device 10.
Timing T13: The flow management table 12 of the flow control device 10 counts the data number transmitted at the timing T11 and the credit number received to obtain data transmission number 12a=“7” and the credit reception number 12b=“2” respectively.
Timing T14: The flow control device 10 transmits the outward MC 70_1 to the flow control device 20, and starts a timer 1 (not shown; timeout t1) and a timer 2 (not shown; timeout t2).

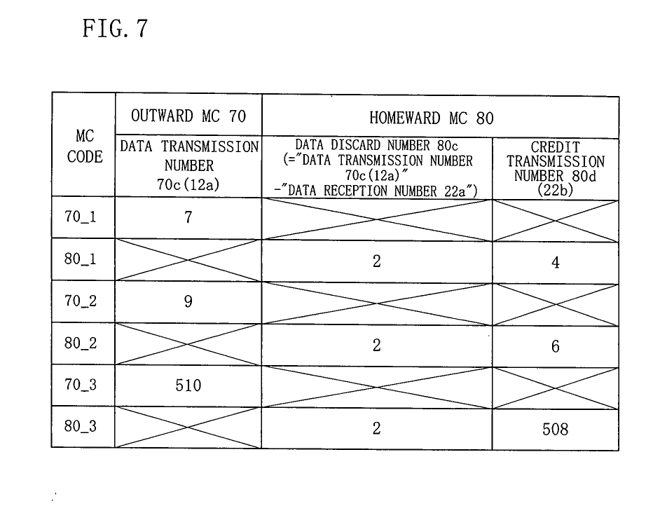

FIG. 7 shows the data transmission number 70c of the outward MC 70 transmitted/received in FIG. 6, the data discard number 80c and the credit transmission number 80d of the homeward MC 80.

Namely, the flow control device 10 sets the data transmission number 12a=“7” of the flow management table 12 in the data transmission number 70c of the outward MC 70 to be transmitted.
Timing T15: The flow control device 20 receives the data 71_5-71_7, and returns the credits 82_3 and 82_4. The credit 82_3 thereamong is discarded (T15a) during the transmission.
Timing T16: In the flow control device 20, as a consequence of the reception and the transmission of the timings T12 and T15, it is rendered in the flow management table 22 that the data reception number 22a=“5” and the credit transmission number 22b=“4”.
Timing T17: In the flow control device 20, it is rendered in the flow management table 22 at this time that the data reception number 22a=“5” and the credit transmission number 22b=“4 (data transfer number)”. Accordingly, the data number temporarily stored in the queue 21_1 is “1 (=5−4)”.

The flow control device 20 receives the outward MC 70_1, and recognizes that the data transmission number 12a transmitted to the queue 21_1=“7”. The flow control device 20 returns the homeward MC 80_1 (see FIG. 7) including the data discard number 80c=“2” that is the difference between the data transmission number 70c=“7” and the data reception number 22a=“5”, and the credit transmission number 80d=“4 (=credit transmission number 22b)” to the flow control device 10, where it is supposed that the homeward MC 80_1 is discarded (T17a) midway.
Timing T18: In the flow control device 10, the data number and the credit number transmitted and received after the timing T14 are respectively added, so that it is rendered in the table 12 that the data transmission number 12a=“9” and the credit reception number 12b=“4”.
Timing T19: Since the response, i.e. the homeward MC 80_1 for the outward MC 70_1 is not returned within the time t2, a timeout occurs in the timer 2. Therefore, the flow control device 10 transmits the outward MC 70_2 (see FIG. 7) to the flow control device 20, and restarts the timer 1 and the timer 2.
Timings T20 and T21: In the flow control device 20, the queue 21_1 further receives the data 71_8 and 71_9, and the credits 82_5 and 82_6 are returned. Therefore, it is rendered in the table 22 that the data reception number 22a=“7” and the credit transmission number 22b=“6”.
Timing T22: The flow control device 20 receives the outward MC 70_2, and returns the homeward MC 80_2 (see FIG. 7).
Timing T23: In the flow control device 10, it is rendered in the table 12 that the data transmission number 12a=“10” and the credit reception number 12b=“5”.
Timing T24: The flow control device 10 receives the homeward MC 80_2, stops the timer 2 and resets the MC reception waiting bit 12d in the table 12 to “0”.
Timing T25: The flow control device 10 corrects the data transmission number 12a in the table 12 to “8” and the credit reception number 12b to “6” based on the data discard number 80c“2” of the homeward MC 80_2 and the credit transmission number 22b“6”. Namely, it is rendered that data transmission number 12a=“8” (the data transmission number 12a“10”−data discard number 80c “2”), and that credit transmission number 80d=“6” credit reception number 12b=“6”.
Timing T26: In the flow control device 10, it is rendered in the table 12 that the data transmission number 12a=“510” and the credit reception number 12b=“506”.
Timing T27: The timeout occurs in the timer 1. Therefore, the flow control device 10 transmits the outward MC 70_3 (see FIG. 7) and starts the timer 2, and sets the MC reception waiting bit of the table 12 to “1”.
Timing T28: In the flow control device 20, it is rendered in the table 22 that the data reception number 22a=“508” and the credit transmission number 22b=“508”. Accordingly, the data number held in the queue 21_1=“0”.
Timing T29: The flow control device 20 receives the outward MC 70_3 and returns the homeward MC 80_3 (see FIG. 7).
Timing T30: In the flow control device 10, it is rendered in the table 12 that the data transmission number 12a=“512” and the credit reception number 12b=“507”.
Timing T31: The flow control device 10 receives the outward MC 80_3, stops the timer 2, and resets the MC reception waiting bit 12d of the table 12 to “0”.
Timing T32: The flow control device 10 corrects the data transmission number 12a to “510” and the credit reception number 12b to “508” in the table 12 based on the data discard number 80c“2” of the homeward MC 80_3 and the credit transmission number 22b “508” respectively.

Thus, it becomes possible to eliminate the deadlock state due to the discard of the data 71 or the credit 82 in the flow control devices 10 and 20 performing a credit-based control.

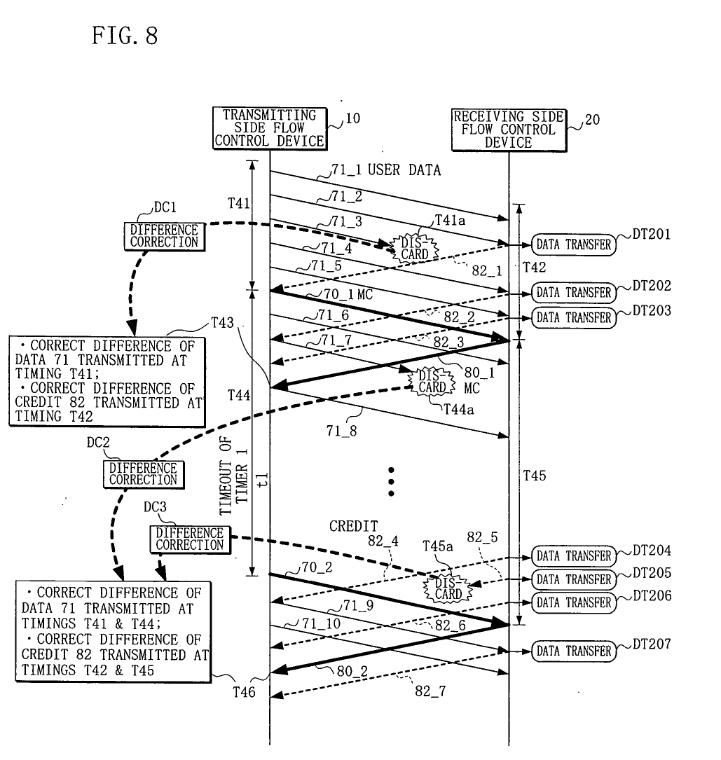

FIG. 8 shows timings at which the discarded data number and the credit number are reflected to the data transmission number 12a and the credit reception number 12b in the flow management table 12 to be corrected in the transmitting side flow control devices 10 and 20 of the present invention.

Namely, at a timing T43 when the transmitting side flow control device 10 has received the homeward MC 80_1 that is a response to the outward MC 70_1, the data transmission number 12a of the flow management table 12 is corrected (DC1) by the number (“1” of the data 71_3 in this example) of the data 71 transmitted at a timing T41 and discarded (T41a). The credit reception number 12b is corrected by the number (“0” in this example) of the credit 82 transmitted at a timing T42 and discarded.

At a timing T46 having received the homeward MC 80_2 that is a response to the outward MC 70_2, the data transmission number 12a of the flow management table 12 is corrected (DC1 and DC2) by the number of the data 71 transmitted at timings T41 and T44 and discarded (T41a and T44a). The credit reception number 12b is corrected (DC3) by the number of the credit 82 transmitted at timings T42 and T45 and discarded (T45a).

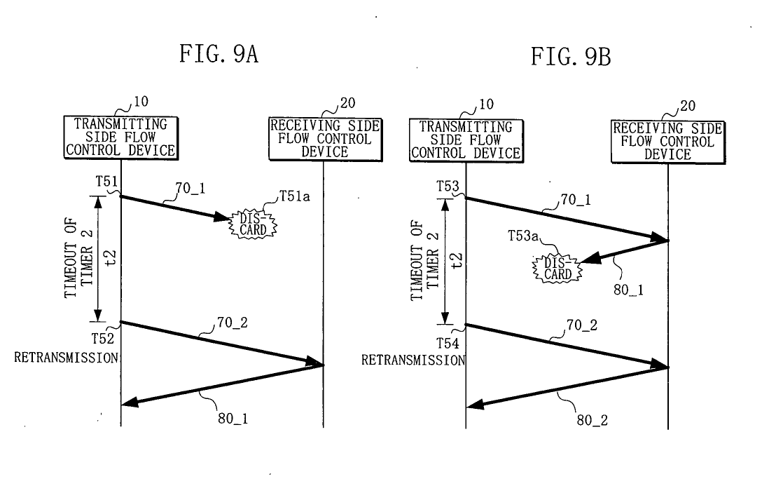

FIGS. 9A and 9B show a case where the outward MC 70 is retransmitted. In FIG. 9A, when the outward MC70_1 transmitted at a timing T51 is discarded (T51a) midway for some reason, the receiving side flow control device 20 does not return the homeward MC 80. Therefore, in the transmitting side flow control device 10, a timeout of the timer 2 which has started at the timing T51 occurs at a timing T52 after the time t2, and the outward MC 70_2 is retransmitted.

In FIG. 9B, the receiving side flow control device 20 receives the outward MC 70_1 transmitted at a timing T53 and returns the homeward MC 80_1. When the returned homeward MC 80_1 is discarded (T53a) midway for some reason, the timeout of the timer 2 which has started at the timing T53 occurs after the time t2 in the transmitting side flow control device 10, and the outward MC 70_2 is retransmitted.

Also, a transmission/reception of the outward MC 70 and the homeward MC 80 performed at intervals of the time t1 by the timer 1 shown in FIG. 6 is reliably performed, thereby enabling the correction of the data transmission number 12a and the credit reception number 12b to be performed before the occurrence of the deadlock.

It is to be noted that in the embodiment shown in the above-mentioned FIGS. 2, 3A, 3B, 4, 5, 6, 7, 8, 9A and 9B, the transmitting side flow control device 10 transmits the data transmission number 12a included in the outward MC 70 (correction information request), and the receiving side flow control device 20 returns the difference between the data transmission number 12a and the data reception number 22a as well as the credit transmission number 22b included in the homeward MC 80 (correction information). Instead, it is possible that the transmitting side flow control device 10 transmits the correction information request (for example, requests by a predetermined bit=“1” of the data cell 71), stores the data transmission number 12a at the transmission time, and the receiving side flow control device 20 returns the data reception number 22a and the credit transmission number 22b included in the homeward MC 80 (correction information).

Thus, it becomes possible for the transmitting side flow control device 10 to obtain “data transmission number 12a”−“data reception number 22a”, and to correct the data transmission number 12a.

As described above, by a flow control device on a transmitting side according to the present invention, a flow management table stores a number of data transmitted to an opposed device and a number of credits received from the opposed device; and a management portion transmits a request for correction information to the opposed device and corrects the data transmission number and the credit reception number based on the correction information received. Therefore, it becomes possible to eliminate a deadlock state with the opposed device due to a discard of data or a credit.

Also, by a flow control device on a receiving side according to the present invention, a management portion notifies to the opposed device the correction information for the data transmission number and the credit reception number of the opposed device in response to the correction information request from the opposed device. Therefore, it becomes possible similarly to eliminate a deadlock state due to a discard of data or a credit.

1. A flow control device on a transmitting side comprising:
a flow management table storing a number of data transmitted to an opposed device and a number of credits received from the opposed device; and
a management portion transmitting a request for correction information to the opposed device and correcting the data transmission number and the credit reception number in the flow management table based on the correction information responded by the opposed device.

2. The flow control device on the transmitting side as claimed in claim 1, wherein the correction information request includes the data transmission number, and the correction information comprises a difference between the data transmission number and a data reception number of the opposed device, and a credit transmission number of the opposed device.

3. The flow control device on the transmitting side as claimed in claim 1, wherein the management portion stores the data transmission number at a time of transmitting the correction information request, and the correction information comprises a data reception number and a credit transmission number of the opposed device.

4. The flow control device on the transmitting side as claimed in claim 1, wherein the management portion transmits the correction information request in a predetermined format at predetermined intervals.

5. The flow control device on the transmitting side as claimed in claim 1, wherein unless the correction information is received within a predetermined time after transmitting the correction information request, the management portion retransmits the correction information request.

6. The flow control device on the transmitting side as claimed in claim 1, further comprising one or more queues temporarily storing the data;
the flow management table managing the data transmission number and the credit reception number corresponding to each queue, and the management portion transmitting the correction information request for each queue.

7. A flow control device on a receiving side comprising:
a queue temporarily storing data received from an opposed device;
a flow management table storing a number of the data received from and a number of credits transmitted to the opposed device; and
a management portion responding correction information for a correction information request from the opposed device.

8. The flow control device on the receiving side as claimed in claim 7, wherein the correction information request includes a data transmission number, and the correction information comprises a difference between a data transmission number of the opposed device and the data reception number, and a credit transmission number.

9. The flow control device on the receiving side as claimed in claim 7, wherein the correction information comprises the data reception number and the credit transmission number.

10. The flow control device on the receiving side as claimed in claim 7, wherein the queue comprises a plurality of queues and the flow management table manages the data reception number and the credit transmission number for each of the queues, and the management portion transmits the correction information for correction information request for each of the queues.
